(19) United States
(12) Patent Application Publication
(10) Pub. No.: US 2026/0330601 A1
(43) Pub. Date: Oct. 22, 2026

(54) REFINED SEPARABLE BILATERAL FILTER FOR BETTER IMAGE QUALITY AND AN IMPROVED DIFFERENCE OF GAUSSIAN DETECTOR

(71) Applicant: QUALCOMM Incorporated, San Diego, CA (US)

(72) Inventors: Aditya C, Bangalore (IN); Saurav GUPTA, Bangalore (IN); Srikar Reddy KUNCHARAPU, Hanamkonda (IN); Arunkumar NEHRUR RAVI, San Diego, CA (US)

(21) Appl. No.: 19/181,083

(22) Filed: Apr. 16, 2025

(51) Int. Cl. G06T 5/20; G06T 7/13

(52) U.S. Cl. CPC G06T 5/20; G06T 7/13; G06T 2207/20024

(57) ABSTRACT

The present disclosure provides techniques for image processing. A method may include applying a Gaussian filter to an input image to generate at least a first filtered image; applying an inverse bilateral filter to the input image to generate at least a second filtered image; generating a first output image based on a subtraction of the second filtered image from the first filtered image; and identifying one or more points of interest in the input image based on at least the first output image.

### INTRODUCTION

### Field of the Disclosure

Aspects of the present disclosure relate to techniques for image processing, and more specifically, image filtering.

### Description of Related Art

Image processing refers to a class of methods that deal with the manipulation of digital images through the use of computational techniques and/or algorithms. A “digital image” (simply referred to herein as an “image”) is an image composed of many equally sized units called “pixels” (short for “picture elements”), each representing a discrete area within the image and being associated with an intensity value (e.g., representing a brightness and/or shade of color for the discrete area). Image processing manipulates images to enhance quality, extract information, and/or transform their structure and/or appearance, such as to prepare the images for interpretation and/or further analysis. For example, image processing is often an important pre-processing step in computer vision applications, such as, object detection, object classification, scene understanding, and facial recognition, to name a few.

Image processing may involve techniques such as image enhancement and/or restoration. Image enhancement may focus on improving an image's appearance, such as by, for example, improving the contrast, sharpness, and/or visibility of specific details represented in the image. Image restoration, on the other hand, may focus on recovering a high-quality estimate of a noisy or degraded image, thereby reversing the effects of imperfections, such as blur, noise, and/or distortion. For example, image denoising may be performed to effectively remove unwanted noise while preserving important details and/or structures represented in an image.

Image filtering (simply referred to herein as “filtering”), e.g., one example image processing technique, may be used to modify and/or enhance an image based on the application of a kernel (e.g., a small matrix of values and/or weights) to one or more pixels of the image (e.g., such as to alter or produce a new value for each pixel where the kernel is applied). Filtering may help to achieve image effects such as smoothing, sharpening, noise reduction, and/or edge enhancement.

### SUMMARY

Certain aspects provide a method for image processing. The method includes obtaining an image comprising a first plurality of pixels associated with a first plurality of pixel intensity values; applying, in a first direction along a first axis of the image, a first bilateral filter to the first plurality of pixel intensity values associated with the first plurality of pixels in the image to generate a first filtered image, wherein: the first bilateral filter is based on a first plurality of weights; the first plurality of weights is based on, at least, the first plurality of pixel intensity values; the first filtered image comprises a second plurality of pixels associated with a second plurality of pixel intensity values; and applying, in a second direction along a second axis of the first filtered image, a second bilateral filter to the second plurality of pixels in the first filtered image to generate a second filtered image, wherein: the second bilateral filter is based on a second plurality of weights; the second plurality of weights is based on, at least, the first plurality of pixel intensity values; and the second filtered image comprises a third plurality of pixels associated with a third plurality of pixel intensity values.

Certain aspects provide a method for interest point detection. The method includes applying a Gaussian filter to an input image to generate at least a first filtered image; applying an inverse bilateral filter to the input image to generate at least a second filtered image; generating a first output image based on a subtraction of the second filtered image from the first filtered image; and identifying one or more points of interest in the input image based on at least the first output image.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 provides an example comparison between Gaussian filtering output and bilateral filtering output generated for an input image.

FIG. 2 depicts example application of a separable bilateral filter to an input image.

FIG. 3 depicts example edge map generation using a separable bilateral filter.

FIG. 4 depicts example difference of inverse bilaterals (DoiB) pyramid generation for interest point detection.

FIG. 5 depicts interest points identified for an example image.

FIG. 6 depicts interest points identified for another example image.

FIG. 7 depicts an example method for image processing.

FIG. 8 depicts an example method for interest point detection.

FIG. 9 depicts aspects of an example apparatus

FIG. 10 depicts aspects of an example apparatus.

### DETAILED DESCRIPTION

Aspects of the present disclosure provide apparatuses, methods, processing systems, and computer-readable mediums for bilateral filtering using a separable bilateral filter. In certain aspects, the separable bilateral filter may be approximated as two bilateral filters, capable of being applied to an input image in different dimensions (e.g., in a two-dimensional (2D) space), to generate a filtered version of the input image, while preserving information about one or more edges represented in the image and without over-smoothing, as described in detail below. In certain aspects, the separable bilateral filter (or another bilateral filter) may applied to an input image at one or more scales, such as to construct a difference of inverse bilaterals (DoiB) pyramid which may be used, at least in some cases, to perform interest point detection for the input image.

Filters used for image filtering may be categorized as “linear” or “non-linear.” A linear filter generally operates by convolving an image with a constant matrix to obtain a linear combination of neighborhood pixel values. For example, a linear filter may generate an output value for a specific pixel by taking a weighted sum of values from neighboring pixels to the specific pixel. A linear relationship may exist between the output of the linear filter and the neighboring pixels' values. A non-linear filter, on the other hand, is a filter whose output is not a linear function of its input. For example, a non-linear filter may use more complex operations than a linear filter to generate an output for a specific pixel, where the operations often involve sorting, ranking, statistics, and/or other functions that do not involve simple weighted sums.

A Gaussian filter is one example linear filter (e.g., a smoothing filter) frequently used to smooth (or “blur”) and reduce (or, in some cases, eliminate) noise in an image. A Gaussian filter works by applying a Gaussian function (e.g., a bell-shaped curve) to an input image to generate a modified version of the image where each pixel's computed intensity value is a weighted average of its surrounding pixels. For example, an image value (I_{c,c}) (e.g., an intensity value) at a pixel location (or position) (p_{c,c}) for a pixel in an image filtered by Gaussian convolution may be given by:

$${I}_{c , c} = {\sum }_{( x , y ) ∈ S} {G}_{σ} ( ‖ {p}_{c , c} - {p}_{x , y} ‖ ) {I}_{x , y}$$

where S represents the set of pixel locations for neighboring pixels (e.g., the “spatial domain”), p_{x,y} represents a pixel location of a neighboring pixel, ∥p_{c,c}−p_{x,y}∥ represents the Euclidean distance between pixel locations p_{c,c} and p_{x,y}, I_{x,y} represents the image value (e.g., an intensity value) at the neighboring pixel associated with pixel location p_{x,y}, and G, (a) represents a 2D Gaussian kernel given by:

$${G}_{σ} ( a ) = \frac{1}{2 π {σ}^{2}} exp ( - \frac{{a}^{2}}{2 {σ}^{2}} )$$

where σ is parameter that defines the neighborhood size.

Per the above equations, the amount of influence a neighbor pixel has on an output pixel's intensity value may depend only on a proximity in location of the neighboring pixel in the image to the output pixel, (e.g., a weight associated with a pixel at pixel location p_{x,y} may be defined by G_{σ}(∥p_{c,c}−p_{x,y}∥)), and not its intensity value. For instance, a bright pixel (e.g., associated with a high intensity value) may have a strong influence over an adjacent dark pixel (e.g., associated with a low intensity value) due to the bright pixel being close in distance to the dark pixel in the image.

While Gaussian filters may be effective for noise reduction and image smoothing, Gaussian filters may inherently blur edges (e.g., represented in an image), making them unsuitable at least for edge-preserving filtering tasks. For example, because Gaussian filtering is performed by considering the distance between pixels and not their intensity values, significant intensity differences between pixels (e.g., generally occurring for pixels in an image that represent edges) may be ignored and instead these pixels may be blurred.

Edge-preserving filtering, used to smooth out noise and/or textures while retaining sharp edges in an image, may be important for visual clarity and/or accurate analysis in downstream applications. Thus, in some cases, other filtering techniques capable of performing edge-preserving smoothing may be used in place of Gaussian filtering. For example, bilateral filtering is one example image filtering technique that has proven to be effective at performing image smoothing and noise reduction while maintaining sharp edges.

Unlike Gaussian filtering, which blurs images irrespective of differences in pixel intensity values, bilateral filtering considers both spatial proximity and intensity value similarity between pixels during smoothing. A neighboring pixel that is close, in terms of both spatial distance and intensity, to a specific pixel in an image may have a strong influence on the pixel's output value computed when smoothing the image, and vice versa. Put differently, a bilateral filter may allow a neighboring pixel to influence another pixel's intensity value only when the neighboring pixel occupies a location nearby the specific pixel and is associated with a similar intensity value as the pixel. This may enable the bilateral filter to smooth portions of an image with similar pixel intensity values, while also preserving edges represented by pixels where the intensity values change sharply.

For example, an image value (I_{c,c}) (e.g., an intensity value) at a pixel location (p_{c,c}) for a pixel in an image filtered using a bilateral filter may be given by:

$${I}_{c , c} = \frac{1}{{W}_{{p}_{c , c}}} {\sum }_{( x , y ) ∈ S} {G}_{{σ}_{s}} ( ‖ {p}_{x , y} - {p}_{c , c} ‖ ) {G}_{{σ}_{i}} ( \vert {I}_{{p}_{x , y}} - {I}_{{p}_{c , c}} \vert ) {I}_{x , y}$$

where S represents the set of pixel locations for neighboring pixels (e.g., the “spatial domain”), p_{x,y} represents a pixel location of a neighboring pixel, ∥p_{x,y}−p_{c,c}∥ represents the Euclidean distance between pixel locations p_{x,y} and p_{c,c}, I_{x,y} represents the image value (e.g., an intensity value) at the neighboring pixel associated with pixel location p_{x,y}, and Wₚ_{_{c,c}} represents a normalization factor (e.g., used to help ensure that the pixel weights sum to one) given by:

$${W}_{{p}_{c , c}} = {\sum }_{( x , y ) ∈ S} {G}_{{σ}_{s}} ( ‖ {p}_{x , y} - {p}_{c , c} ‖ ) {G}_{{σ}_{i}} ( \vert {I}_{{p}_{x , y}} - {I}_{{p}_{c , c}} \vert )$$

Further, G_{σ}, may represent the “spatial Gaussian weight,” which is based on the spatial difference between pixel location p_{c,c} and pixel location p_{x,y}, and G_{σ}_{ᵢ} may represent the “intensity Gaussian weight,” which is based on the intensity value difference between the intensity value associated with the pixel at pixel location p_{c,c} and the intensity value associated with the pixel at pixel location p_{x,y}.

Thus, per the above equations, a weight (w), associated with a neighboring pixel at location p_{x,y}, in a generic 2D bilateral filter may be given by:

Wₚ_{_{x,y}}=G_{σ}_{ₛ}(∥p_{x,y}−p_{c,c}∥)G_{σ}_{ᵢ}(|Iₚ_{_{x,y}}−Iₚ_{_{c,c}}|)

Here, the spatial Gaussian weight (G_{σ}_{ₛ}) may decrease the weight (w), or influence, of the neighboring pixel at location p_{x,y} when the neighboring pixel is located far away from the pixel at pixel location p_{c,c} (e.g., decrease the influence of distant pixels). Further, the intensity Gaussian weight (G_{σ}_{ᵢ}) may decrease the weight (w), or influence, of the neighboring pixel at location p_{x,y} when the intensity value (Iₚ_{_{x,y}}) associated with the neighboring pixel differs from the intensity value associated with the pixel at pixel location p_{c,c} (e.g., decrease the influence of pixels with differing intensity values).

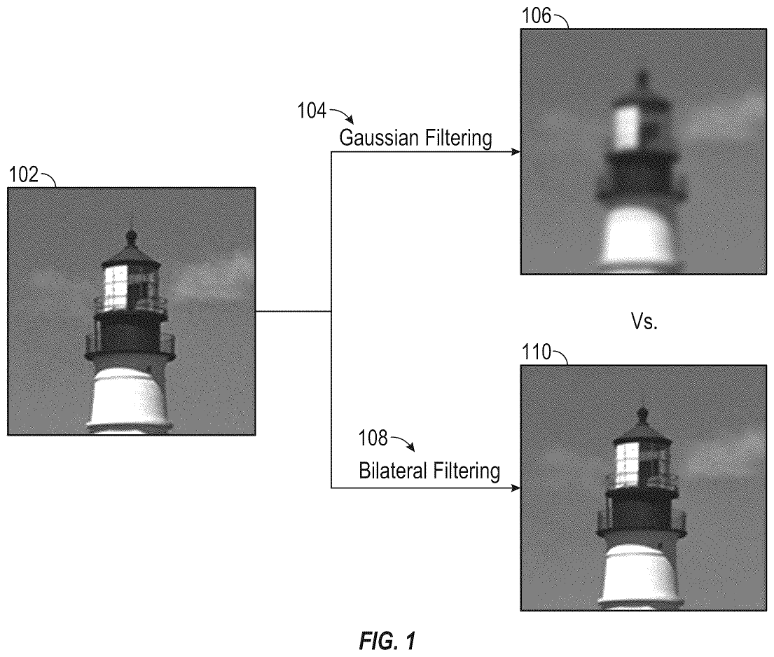

In practice, this makes bilateral filters more beneficial than Gaussian filters for performing edge-preserving smoothing. For example, as shown in FIG. 1, an input image 102 may comprise multiple pixels representing a light house in a scene during a first time period. A Gaussian filter applied to the input image 102 (e.g., during Gaussian filtering 104) may produce output image 106, while a bilateral filter applied to the same input image 102 (e.g., during bilateral filtering 108) may produce output image 110. As shown in FIG. 1, while both filters may be capable of smoothing (e.g., blurring) input image 102, the bilateral filter may help to preserve edges associated with the light house depicted in the scene (and represented by pixels in input image 102), unlike the Gaussian filter (e.g., the edges of the light house represented by pixels in output image 106 are blurred).

Despite its widespread use, bilateral filtering is a computationally expensive technique used in image processing, at least due to its non-linear combination of spatial and intensity filters. For example, for an image with multiple pixels, bilateral filtering may require, for each pixel and each of its corresponding neighboring pixels, the computation of two weights (e.g., the spatial Gaussian weight and the intensity Gaussian weight), their products, and the performance of a weight normalizing step. In some cases, such as for large frames (e.g., including a larger number of pixels) associated with engine for video analytics (EVA) hardware (e.g., up to 8K) and/or high frames per second (FPS) videos, for example, the computational cost of the bilateral filter may cause the bilateral filter to be an impractical solution for image processing, despite the quality improvements it offers.

Further, the non-linearity of the bilateral filter may prevent this filter from being separable, thereby making it computationally expensive to run on hardware. For example, in image filtering, “separability” refers to the ability of a 2D filter to be decomposed into a sequence of two one-dimensional (1D) filters in different directions (e.g., typically applied along the horizontal direction and then the vertical direction of an image). As such, a 2D convolution may be performed as two 1D convolutions. For example, a first filtering pass may involve applying a first of the two filters to the image to convolve the image in a first direction (e.g., a horizontal direction), and then a second filtering pass may involve applying a second of the two filters to the image (e.g., the filtered image) to further convolve the image in a second direction (e.g., the vertical direction). The intermediate results from applying the first filter, prior to applying the second filter, may be stored, for example, in memory.

A Gaussian filter (e.g., a 2D kernel) is an example separable filter that may be separated into two 1D kernels applied along an x-axis and a y-axis (e.g., orthogonal axes) of an image. As an illustrative example, a 3×3 Gaussian kernel may be given by:

$${G}_{{σ}_{s}} = \frac{1}{16} [ \begin{matrix}1 & 2 & 1 \\ 2 & 4 & 2 \\ 1 & 2 & 1\end{matrix} ] = \frac{1}{4} [ \begin{matrix}1 \\ 2 \\ 1\end{matrix} ] \cdot \frac{1}{4} [ 121 ]$$

where a first 1D kernel of the 3×3 Gaussian kernel, applied in a first direction, such as along a y-axis of the image, may be represented as:

$${G}_{{σ}_{s} , {F}_{Y}} = \frac{1}{4} [ \begin{matrix}1 \\ 2 \\ 1\end{matrix} ]$$

and a second 1D kernel of the 3×3 Gaussian kernel, applied in a second direction, such as along an x-axis of an image, may be represented as:

$${G}_{{σ}_{s} , {F}_{X}} = \frac{1}{4} [ 121 ]$$

The separability of the Gaussian filter may help to speed up, as well as reduce the computational cost associated with using a Gaussian filter to perform image processing tasks. Unfortunately, this functionality, which allows for more efficient and less resource-intensive computation, is not a characteristic of bilateral filters. For example, because the intensity Gaussian weight cannot be separated, the product of the spatial Gaussian weight and the intensity Gaussian weight computed when calculating the weight (w) for a neighboring pixel to another pixel in an image (e.g., representing the influence the neighboring pixel has on the pixel's computed intensity value) may not be separated into two 1D kernels. Specifically, for a 2D filter to be separable, it may need to have a rank of 1, meaning only one row is unique, while the remaining rows are linearly dependent on others. The intensity Gaussian filter weights are dependent on a difference between a center pixel at position (c,c) and a pixel at position (x,y); thus, all weights in the 2D matrix may be unique. A non-separable filter, such as the bilateral filter, may have a higher computational cost compared to separable filters, like the Gaussian filter.

For at least the aforementioned reasons, the bilateral filter may be limited in application by its speed and/or computational cost.

Certain aspects described herein overcome the aforementioned technical problems and provide a technical benefit to the field of computer vision. Specifically, certain aspects described herein provide an efficient, separable implementation of the bilateral filter, which may, in some cases, be used for image processing. Specifically, the bilateral filter described herein may be approximated as two bilateral filters, capable of being applied in different dimensions in a 2D space. For example, a first approximation of the bilateral filter (referred to herein as a “first bilateral filter”) may be used to filter an input image in a first dimension (e.g., in a first direction along a first axis of the image) to generate a first filtered image. This first filtered image (e.g., the intermediate output (IO) of the first filtering pass) may then be filtered again in a second dimension (e.g., in a second direction along second axis of the image) using a second approximation of the bilateral filter (referred to herein as a “second bilateral filter”) to generate a second filtered image. The second filtered image may comprise a blurred or smoothed version of the input image that preserves one or more edges represented in the input image.

The first bilateral filter may be applied to the input image using weights (e.g., for neighboring pixels) calculated based on intensity values associated with pixels in the input image. Further, the second bilateral filter may be applied to the first filtered image (e.g., the intermediate output) using weights (e.g., for neighboring pixels) also calculated based the on the intensity values associated with pixels in the input image. Calculation of the weights for the second bilateral filter based on the intensity values associated with pixels in the input image, instead of the intensity values associated with pixels in the first filtered image (e.g., the intermediate output), may help to avoid over blurring/over smoothing the input image during filtering, such that this information is preserved for subsequent applications and/or analysis.

The separable bilateral filter described herein may provide one or more various beneficial technical effects and/or advantages. For example, the separable bilateral filter may help to achieve improved filtering capability and accuracy, for example, in edge-preserving filtering tasks, without the computational costs and inefficiencies generally associated with performing such filtering. The improved filtering capability and accuracy may be attributable to the second approximation of the bilateral filter being based on weights calculated from pixel intensities of an input image rather than pixel intensities of the intermediate output resulting from the application of the first approximation of the bilateral filter. As described herein, this may help to better preserve edge information in the input image. In some cases, due to the edge preserving nature of the separable bilateral filter described herein, the filter may be capable of producing better results (e.g., filtered output images) compared to the standard Gaussian filter. The reduction in computational cost and increased efficiency may be attributable to the bilateral filter's separable implementation. For example, by approximating the filter as two bilateral filters, capable of being applied in different dimensions in a 2D space, the computational complexity may be reduced, thereby leading to faster processing times, even for images with a large number of pixels.

In certain aspects, the separable bilateral filter described herein may additionally help to achieve increased power gains. For example, for a fixed latency, dynamic power may be reduced as a result of the decrease in computational complexity associated with the application of the filter, thereby leading to additional power gains. This decrease in complexity may directly map to a reduction in area as well.

Notably, the efficiency that may be achieved by the separable bilateral filter described herein may directly benefit applications in various domains, and in some cases, may replace a Gaussian filter as part of its pre-processing pipeline. Example applications which may benefit from the use of the separable bilateral filter may include applications for image denoising, tone mapping, up-sampling, dense motion map pipelines, edge detection, data fusion using a cross-bilateral filter (e.g., a multispectral fusion or flash/no-flash imaging), a three-dimensional (3D) fairing via mesh smoothing (3DR), and/or regularized optical flow, to name a few.

In certain aspects, the separable bilateral filter may be used for interest point detection. Specifically, “interest point detection” may refer to a process for identifying interest points in an image. “Interest points,” also commonly referred to as “key points” or “feature points,” may refer to points, regions, and/or structures of interest (e.g., significant points, regions, and/or structures) in an image, which in some cases, may be used as references for further analysis (e.g., serve as reference points for computer vision tasks such as image matching, object recognition, structure from motion, etc.). Interest points may be characterized by their uniqueness, repeatability (e.g., some interest points may not be easily repeatable in various lighting conditions and/or perspectives), and robustness to variations such as lighting changes, rotations, and/or scale transformations. Example interest points may include distinctive or salient points, corners, edges, and/or blobs in an image, to name a few.

As described herein, in certain aspects, the separable bilateral filter may be used to construct a DoiB pyramid for interest point detection. For example, the separable bilateral filter, with its intensity weigh coefficients inverted (referred to herein as a “separable inverse bilateral filter” with “inverse intensity Gaussian weights,” also referred to as “inverse intensity weights” or “inverted intensity weights”), may be applied to an input image at one or more different scales to generate one or more first filtered images, or blurred versions of the input image where edge information is preserved. Further, a Gaussian filter may be applied to the input image at one or more different scales to generate one or more second filtered images. A second filtered image may be subtracted from one or more of the first filtered images or one or more of the other second filtered images to generate one or more output images, which may be arranged in a pyramid-like structure to create the DoiB pyramid. Specifically, each layer of the DoiB pyramid may correspond a (1) a difference between two filtered images generated by applying the Gaussian filter at different scales or (2) a difference between a filtered image generated by applying the separable inverse bilateral filter at a first scale and a filtered image generated by applying a Gaussian filter as a second scale. The output images included in the DoiB pyramid may help to identify areas of significant pixel intensity value variation in the input image, which may correspond to or represent “interest points” (e.g., edges, corners, blobs, etc.) in the input image.

In certain aspects, the DoiB pyramid constructed, using the techniques described herein, for interest point detection may provide significant technical advantages over conventional solutions, which generally construct a difference of Gaussian (DoG) pyramid for performing the same task.

For example, a DoG pyramid may represent a structure generated based on the subtraction of gaussian blurred versions of an input image (e.g., filtered images created based on applying a Gaussian filter at different scales, and with different standard deviations) from one another (e.g., a DoG algorithm may represent a bandpass operation and can be seen as an approximation to the Laplacian of Gaussian operator). The DoG pyramid may help to enhance the visibility of edges and/or other details in the input image. Unlike other sharpening filters that may enhance high frequency details and/or consequently increase noise, DoG may effectively highlight edges in the input image while minimizing noise enhancement. As such, DoG pyramids have proven to be useful tools for performing interest point detection (e.g., including blob detection), including, for example, scale-invariant feature transform (SIFT) interest point detection (e.g., a subset of technique that fall within the broader category for interest point detection).

A technical problem associated with the use of a DoG algorithm to produce a DoG pyramid, such as for interest point detection, involves the inherent reduction in overall image contrast that results when using the DoG algorithm to generate output images that make up the DoG pyramid. In certain aspects, this loss in contrast may be attributed to the use of a Gaussian filter, which uniformly blurs the entire input image (e.g., as described in detail above).

The DoiB pyramid constructed using the techniques described herein helps to overcome this technical problem based on the use of the separable inverse bilateral filter. That is, the application of the separable inverse bilateral filter may beneficially help to preserve edges while selectively smoothing an input image (e.g., at different scales). This may help to maintain the contrast between different regions in the input image, effectively addressing the contrast loss issue associated with the use of the Gaussian filter in DoG pyramid construction (e.g., for interest point detection).

In certain aspects, the separable inverse bilateral filter described herein may be applied to an input image for DoiB pyramid construction such that advantages associated with the use of this filter may be realized, including, for example, improved filtering capability and accuracy, with increased efficiency and reduced computational complexity and cost. It is noted however that in certain other aspects, one or more other types of bilateral filters may be used as an alternative to the use of the separable inverse bilateral filter. That is, a DoiB pyramid may be constructed based on the application of any bilateral filter to an input image at one or more different scales to thereby generate the DoiB pyramid described herein, which may be used, for example, for interest point detection.

### Aspects Related to a Refined Separable Bilateral Filter

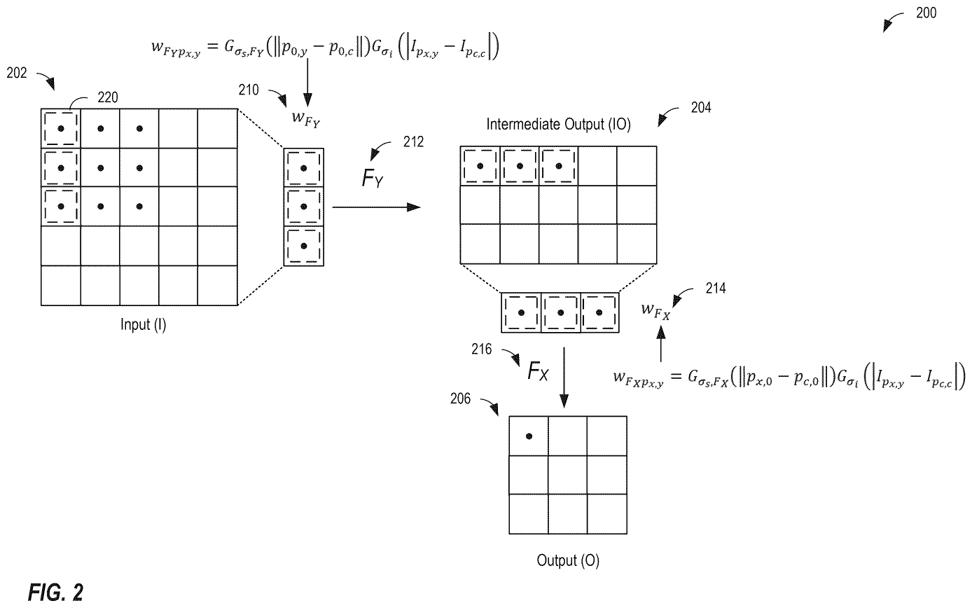

FIG. 2 depicts example application of the separable bilateral filter described herein to an input image 202. In certain aspects, the separable bilateral filter may be applied to the input image 202 to efficiently generate a smoothed version (or blurred version) of the input image 202 that preserves one or more images represented in the image. For example, in certain aspects, the input image 202 may comprise the input image 102 shown in FIG. 1, and the separable bilateral filter may be applied to generate output image 110, with the edge information preserved, such as in a computationally and time efficient manner.

The input image 202 in FIG. 2 may include multiple pixels 220 arranged in a regular 2D grid, forming multiple row and columns. Each pixel 220 may be associated with an intensity value (Iₚ_{_{x,y}} where p_{x,y} represents the spatial location of the specific pixel 220 in input image 202) representing the pixel's brightness and/or color. A pixel associated with a higher intensity value may represent a brighter (or more white, where input image 202 is in grayscale) pixel, while a pixel associated with a lower intensity value may represent a darker (or more black, where input image 202 is in grayscale) pixel in input image 202. In certain aspects, a large variation in intensity values associated with pixels 220 that are close in proximity to one another in input image 202 may indicate that such pixels 220 are associated with an edge and its surroundings represented in input image 202.

The separable bilateral filter may be approximated as two bilateral filters, capable of being applied in different dimensions in a 2D space. For example, a first bilateral filter (e.g., a first approximation of the bilateral filter), F_{Y}, may be applied to input image 202 in a first direction along a y-axis of the input image 202 to generate a first filtered image 204. Further, a second bilateral filter (e.g., a second approximation of the bilateral filter), F_{X}, may be applied to first filtered image 204 in a second direction along an x-axis of the first filtered image 204 to generate the second filtered image 206. Thus, the first bilateral filter F_{Y} and the second bilateral filter F_{X} may be applied in cascade to generate second filtered image 206. In this example, input image 202 may represent the input (I) of the bilateral filter, the first filtered image 204 may represent the intermediate output (IO) of the bilateral filter, and the second filtered image 206 may represent the output (O) of the bilateral filter.

The first bilateral filter F_{Y} may be based on multiple weights (W_{F}_{_{Y}}). As shown in FIG. 2, the weights (W_{F}_{_{Y}}) may be calculated based on pixel intensities (Iₚ_{_{x,y}} values) associated with neighboring pixels to a specific pixel in input image 202. For example, a weight

$$( {w}_{{F}_{Y} , {p}_{x , y}} )$$

for a neighboring pixel 220 located at position x,y (p_{x,y}) (e.g., a neighboring pixel 220 to a pixel 220 at position c,c (p_{x,y})) may be calculated as:

$${w}_{{F}_{Y} {p}_{x , y}} = {G}_{{σ}_{s} , {F}_{Y}} ( ‖ {p}_{0 , y} - {p}_{0 , c} ‖ ) {G}_{{σ}_{i}} ( \vert {I}_{{p}_{x , y}} - {I}_{{p}_{c , c}} \vert )$$

The second bilateral filter F_{X} may be based on multiple weights (W_{F}_{_{X}}). As shown in FIG. 2, the weights (W_{F}_{_{X}}) may be calculated based on pixel intensities (Iₚ_{_{x,y}} values) associated with neighboring pixels to a specific pixel in input image 202. For example, a weight

$$( {w}_{{F}_{X} , {p}_{x , y}} )$$

for a neighboring pixel 220 located at position x,y (p_{x,y}) (e.g., a neighboring pixel 220 to a pixel 220 at position c,c (p_{x,y})) may be calculated as:

$${w}_{{F}_{X} {p}_{x , y}} = {G}_{{σ}_{s} , {F}_{X}} ( ‖ {p}_{x , 0} - {p}_{c , 0} ‖ ) {G}_{{σ}_{i}} ( \vert {I}_{{p}_{x , y}} - {I}_{{p}_{c , c}} \vert )$$

More specifically, instead of calculating the weights (W_{F}_{_{X}}) based on pixel intensities (IOₚ_{_{x,y}} values) associated with neighboring pixels to a specific pixel in first filtered image 204 (e.g., the intermediate output), such that the weights are calculated based on G_{σ}_{ᵢ}(|IOₚ_{_{x,y}}−IOₚ_{_{c,c}}), the weights (W_{F}_{_{X}}) may be calculated based on pixel intensities (Iₚ_{_{x,y}} values) associated with neighboring pixels to a specific pixel in input image 202.

As an illustrative example, input image 202 may include first pixels 220 at pixel locations p₀₀ to p₂₂. Intensity values associated with first pixels 220 may include intensity values Iₚ_{₀₀} to Iₚ_{₂₂}. The intermediate output (IO) (e.g., the first filtered image 204 generated) after convolution with the first bilateral filter F_{Y}, along the columns of input image 202 (e.g., considering a 3×3 separable kernel approximation for the spatial Gaussian) may be given by:

$$IO = [ \begin{matrix}{p}_{00} & {p}_{1} & {p}_{2} \\ {p}_{10} & {p}_{11} & {p}_{12} \\ {p}_{20} & {p}_{21} & {p}_{22}\end{matrix} ] * {w}_{{F}_{Y}} = [ \begin{matrix}sum ( \begin{matrix}{p}_{00} * 1 * {G}_{{σ}_{i}} ( \vert {I}_{{p}_{00}} - {I}_{{p}_{10}} \vert ) \\ {p}_{10} * 2 * {G}_{{σ}_{i}} ( \vert {I}_{{p}_{10}} - {I}_{{p}_{10}} \vert ) \\ {p}_{20} * 1 * {G}_{{σ}_{i}} ( \vert {I}_{{p}_{20}} - {I}_{{p}_{10}} \vert )\end{matrix} ) sum ( \begin{matrix}{p}_{1} * 1 * {G}_{{σ}_{i}} ( \vert {I}_{{p}_{1}} - {I}_{{p}_{11}} \vert ) \\ {p}_{11} * 2 * {G}_{{σ}_{i}} ( \vert {I}_{{p}_{11}} - {I}_{{p}_{11}} \vert ) \\ {p}_{21} * 1 * {G}_{{σ}_{i}} ( \vert {I}_{{p}_{21}} - {I}_{{p}_{11}} \vert )\end{matrix} ) \\ sum ( \begin{matrix}{p}_{2} * 1 * {G}_{{σ}_{i}} ( \vert {I}_{{p}_{2}} - {I}_{{p}_{12}} \vert ) \\ {p}_{12} * 2 * {G}_{{σ}_{i}} ( \vert {I}_{{p}_{12}} - {I}_{{p}_{12}} \vert ) \\ {p}_{22} * 1 * {G}_{{σ}_{i}} ( \vert {I}_{{p}_{22}} - {I}_{{p}_{12}} \vert )\end{matrix} )\end{matrix} ]$$

Further, the output (O) (e.g., the second filtered image 206 generated) after convolution with the second bilateral filter F_{X}, along the rows of first filtered image 204 may be given by:

$$O = IO * {w}_{{F}_{x}} = sum ( [ \begin{matrix}\begin{matrix}{p}_{00} * 1 * {G}_{{σ}_{i}} ( \vert {I}_{{p}_{00}} - {I}_{{p}_{10}} \vert ) * \\ {G}_{{σ}_{i}} ( \vert {I}_{{p}_{10}} - {I}_{{p}_{11}} \vert )\end{matrix} & {p}_{1} * 1 * {G}_{{σ}_{i}} ( \vert {I}_{{p}_{1}} - {I}_{{p}_{11}} \vert ) * 2 & \begin{matrix}{p}_{2} * 1 * {G}_{{σ}_{i}} ( \vert {I}_{{p}_{2}} - {I}_{{p}_{12}} \vert ) * \\ {G}_{{σ}_{i}} ( \vert {I}_{{p}_{12}} - {I}_{{p}_{11}} \vert )\end{matrix} \\ {p}_{10} * 2 * {G}_{{σ}_{i}} ( \vert {I}_{{p}_{10}} - {I}_{{p}_{11}} \vert ) & {p}_{11} * 2 * {G}_{{σ}_{i}} ( \vert {I}_{{p}_{11}} - {I}_{{p}_{11}} \vert ) * 2 & {p}_{12} * 2 * {G}_{{σ}_{i}} ( \vert {I}_{{p}_{12}} - {I}_{{p}_{11}} \vert ) \\ \begin{matrix}{p}_{20} * 1 * {G}_{{σ}_{i}} ( \vert {I}_{{p}_{20}} - {I}_{{p}_{10}} \vert ) * \\ {G}_{{σ}_{i}} ( \vert {I}_{{p}_{10}} - {I}_{{p}_{11}} \vert )\end{matrix} & {p}_{21} * 1 * {G}_{{σ}_{i}} ( \vert {I}_{{p}_{21}} - {I}_{{p}_{11}} \vert ) * 2 & \begin{matrix}{p}_{22} * 1 * {G}_{{σ}_{i}} ( \vert {I}_{{p}_{22}} - {I}_{{p}_{12}} \vert ) * \\ {G}_{{σ}_{i}} ( \vert {I}_{{p}_{12}} - {I}_{{p}_{11}} \vert )\end{matrix}\end{matrix} ] )$$

In this example, to simplify the entries, G_{σ}_{ᵢ}(0) may be equal to 1.

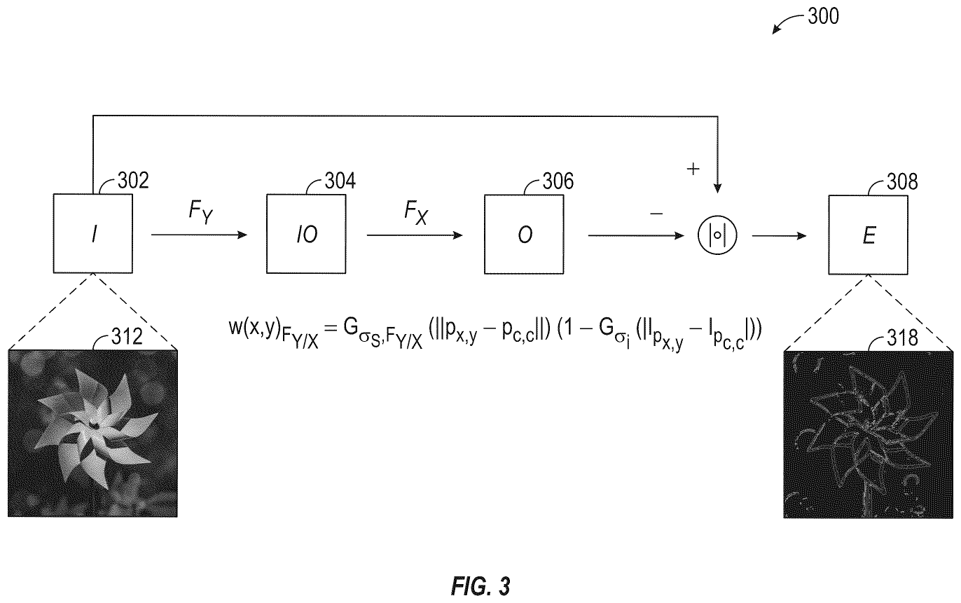

In certain aspects, an edge map may be generated based on inverting the intensity Gaussian weight coefficients in the equations provided above for the separable bilateral filer. As used herein, an “edge map” may refer to an image where edges and/or boundaries represented in the image are identified. The edges and/or boundaries may be associated with regions of pixels in the image with high variations in pixel intensity values. FIG. 3 depicts example edge map (E) generation 300 using the separable bilateral filter described herein. For example, edge map generation 300 may be used to generate an edge map (E) 308 for an input image 302 (e.g., shown as input (I)).

As shown in FIG. 3, similar to FIG. 2, a first bilateral filter, F_{Y}, may be applied to input image 302 in a first direction, such as vertically along a y-axis, of the input image 202 to generate a first filtered image 304 (e.g., shown as intermediate output (IO)). The first bilateral filter F_{Y} may be based on multiple weights (W_{F}_{_{Y}}). Different from FIG. 2, however, each weight (W_{F}_{_{Y}}) may be calculated based on inverting the intensity Gaussian weight coefficients. For example, a weight

$$( {w}_{{F}_{Y} , {p}_{x , y}} )$$

for a neighboring pixel 220 located at position x,y (p_{x,y}) (e.g., a neighboring pixel 220 to a pixel 220 at position c,c (p_{x,y})) may be calculated as:

$${w}_{{F}_{Y} {p}_{x , y}} = {G}_{{σ}_{s} , {F}_{Y}} ( ‖ {p}_{0 , y} - {p}_{0 , c} ‖ ) ( 1 - {G}_{{σ}_{i}} ( \vert {I}_{{p}_{x , y}} - {I}_{{p}_{c , c}} \vert ) )$$

A second bilateral filter, F_{X}, may be applied to first filtered image 304 in a second direction, such as horizontally along an x-axis of the first filtered image 304, to generate a second filtered image 306 (e.g., shown as output (O)). The second bilateral filter F_{X} may be based on multiple weights (W_{F}_{_{X}}). Different from FIG. 2 however, each weight (W_{F}_{_{X}}) may be calculated based on inverting the intensity Gaussian weight coefficients. For example, a weight

$$( {w}_{{F}_{X} , {p}_{x , y}} )$$

for a neighboring pixel 220 located at position x,y (p_{x,y}) (e.g., a neighboring pixel 220 to a pixel 220 at position c,c (p_{x,y})) may be calculated as:

$${w}_{{F}_{X} {p}_{x , y}} = {G}_{{σ}_{s} , {F}_{X}} ( ‖ {p}_{x , 0} - {p}_{c , 0} ‖ ) ( 1 - {G}_{{σ}_{i}} ( \vert {I}_{{p}_{x , y}} - {I}_{{p}_{c , c}} \vert ) )$$

Edge map 308 may then be created based on subtracting input image 302 from second filtered image 306.

An example edge map 318 generated for an input image 312 using edge map generation 300 is shown in FIG. 3.

### Aspects Related to DoiB Pyramid Generation for Interest Point Detection

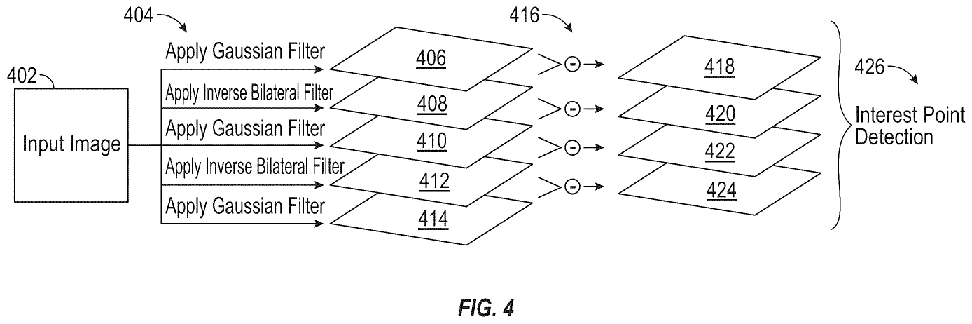

FIG. 4 depicts example DoiB pyramid generation 400, such as for interest point detection. As shown in FIG. 4, DoiB pyramid generation 400 may involve the application (e.g., at 404) of a Gaussian filter and a bilateral filter to an input image 402 in an alternating fashion, such that filtered images (e.g., filtered images 406-414) generated during DoiB pyramid generation 400 are generated using alternating image filters. These filtered images 406-414 may be used to generate (e.g., at 416) output images 418-424, which may be used for interest point detection 426. In this example, each output image 418-424 may represent an edge map that may be used for interest point detection 426.

More specifically, the input image 402 in FIG. 4 may include multiple pixels arranged in a regular 2D grid, forming multiple row and columns. Each pixel may be associated with an intensity value representing the pixel's brightness and/or color. In certain aspects, a large variation in intensity values associated with pixels in input image 402 may indicate that such pixels represent an edge (and its surroundings) in input image 402.

As shown in example DoiB pyramid generation 400 in FIG. 4, at 404, a Gaussian filter may be applied to input image 402 to generate filtered images 406, 410, and 414 for input image 402. The Gaussian filter may be applied at different scales such that filtered images 406, 410, and 414 are different. Applying a Gaussian filter at different scales may refer to the application of the Gaussian filter with varying standard deviations (e.g., varying σ values), such as to create filtered images 406, 410, and 414 with varying levels of details from input image 402 being smoothed (or blurred or removed).

Further, at 404, an inverse bilateral filter may be applied to input image 402 to generate filtered images 408 and 412 for input image 402. The inverse bilateral filter may be applied at different scales such that filtered images 408 and 412 are different. Applying an inverse bilateral filter at different scales may refer to the application of the inverse bilateral filter with varying standard deviations (e.g., varying σ values), such as to create filtered images 408 and 412 with varying levels of details from input image 402 being smoothed (or blurred or removed).

In certain aspects, the inverse bilateral filter applied to input image 402 comprises a bilateral filter with its intensity Gaussian weight coefficients inverted. For example, a weight

$$( {w}_{F , {p}_{x , y}} )$$

for a neighboring pixel 220 located at position x,y (p_{x,y}) (e.g., a neighboring pixel 220 to a pixel 220 at position c,c (p_{x,y})) may be calculated as:

$${w}_{{Fp}_{x , y}} = {G}_{{σ}_{s} , F} ( ‖ {p}_{x , y} - {p}_{c , c} ‖ ) ( 1 - {G}_{{σ}_{i}} ( \vert {I}_{{p}_{x , y}} - {I}_{{p}_{c , c}} \vert ) )$$

In certain aspects, the inverse bilateral filter applied to input image 402 comprises the separable inverse bilateral filter described in detail above. For example, a first bilateral filter, F_{Y}, may be applied to input image 402 in a first direction, such as vertically along a y-axis, of the input image 402 to generate intermediate filtered images (e.g., intermediate output (IO)). The first bilateral filter F_{Y} may be based on multiple weights (W_{F}_{_{Y}}). Each weight (W_{F}_{_{Y}}) may be calculated based on inverting its intensity Gaussian weight coefficients. For example, a weight

$$( {w}_{{F}_{Y} , {p}_{x , y}} )$$

for a neighboring pixel located at position x,y (p_{x,y}) (e.g., a neighboring pixel to a pixel at position c,c (p_{x,y})) may be calculated as:

$${w}_{{F}_{Y} {p}_{x , y}} = {G}_{{σ}_{s} , {F}_{Y}} ( ‖ {p}_{0 , y} - {p}_{0 , c} ‖ ) ( 1 - {G}_{{σ}_{i}} ( \vert {I}_{{p}_{x , y}} - {I}_{{p}_{c , c}} \vert ) )$$

A second bilateral filter, F_{X}, may be applied to the intermediate filtered images in a second direction, such as horizontally along an x-axis of the first filtered image 304, to generate filtered images 408 and 412. The second bilateral filter F_{X} may be based on multiple weights (W_{F}_{_{X}}). Each weight (W_{F}_{_{X}}) may be calculated based on inverting its intensity Gaussian weight coefficients. For example, a weight

$$( {w}_{{F}_{X} , {p}_{x , y}} )$$

for a neighboring pixel located at position x,y (p_{x,y}) (e.g., a neighboring pixel to a pixel at position c,c (p_{x,y})) may be calculated as:

$${w}_{{F}_{X} {p}_{x , y}} = {G}_{{σ}_{s} , {F}_{X}} ( ‖ {p}_{x , 0} - {p}_{c , 0} ‖ ) ( 1 - {G}_{{σ}_{i}} ( \vert {I}_{{p}_{x , y}} - {I}_{{p}_{c , c}} \vert ) )$$

At 416, output images 418-424 (e.g., “DoiB images”) at different scales may be generated. For example, output image 418 may be generated based on subtracting filtered image 406 (e.g., filtered using the Gaussian filter) from filtered image 408 (e.g., filtered using the inverse bilateral filter). Similarly, output image 420 may be generated based on subtracting filtered image 408 (e.g., filtered using the inverse bilateral filter) from filtered image 410 (e.g., filtered using the Gaussian filter), output image 422 may be generated based on subtracting filtered image 410 (e.g., filtered using the Gaussian filter) from filtered image 412 (e.g., filtered using the inverse bilateral filter), and output image 424 may be generated based on subtracting filtered image 412 (e.g., filtered using the inverse bilateral filter) from filtered image 414 (e.g., filtered using the Gaussian filter).

Output images 418-424 may be organized in a pyramid-like structure to construct the DoiB pyramid. One or more of the output images 418-424 included in the DoiB pyramid may be used to perform interest point detection for input image 402, such as to detect one or more interest points represented in input image 402. The identified interest points may be used for various downstream applications, including image matching, object recognition, structure from motion, and/or the like.

Although FIG. 4 describes the use of output image(s) 418-424 in the DoiB pyramid for interest point detection, in some other examples, the output image(s) 418-424 may be used for one or more other applications.

Further, although FIG. 4 describes the application of the Gaussian filter to input image 402 to generate three filtered images 406, 410, and 414 and the inverse bilateral filter to input image 402 to generate two filtered images 408 and 412, in certain other examples, (1) the Gaussian filter may be applied to input image 402 to generate less than three or more than three filtered images and/or (2) the bilateral filter may be applied to input image 402 to generate less than two or more than two filtered images.

Further, in some other examples, the Gaussian filter and the bilateral filter may not be applied to input image 402 in an alternating pattern, as shown in FIG. 4. For example, the bilateral and Gaussian layers of the DoiB pyramid may be programmatically selected at each layer based on the target application. This selection may affect which filter is applied, at each layer, to input image 402. For instance, in one example, the inverse bilateral filter and the Gaussian filer may be applied in an alternating fashion to create alternating layers (e.g., alternating filtered images) such that output images generated at the top of the DoiB pyramid are generated based on the inverse bilateral and Gaussian filtered images. However, only the Gaussian filter may be applied to input image 402 to create layers (e.g., Gaussian-filtered images) such that output images generated at the bottom of the DoiB pyramid are generated based on the difference between Gaussian-filtered images only. In certain aspects, this may help with the detection of interest points inside blobs (e.g., interest points within an interior of a spatial location in an image) and/or interest points around corners and edges represented in input image 402, such as during interest point detection 426.

An example advantage of creating a DoiB pyramid, as opposed to a DoG pyramid, is that DoiB pyramid uses a bilateral filter that is capable of preserving edges represented in an input image while also selectively smoothing the input image. This may help to maintain the contrast between different regions in the input image, effectively addressing the contrast loss issue encountered when using a Gaussian filter to generate a DoG pyramid.

In certain aspects, output images included in a DoiB pyramid may include output images generated for an input image that enhance the visibility of edges represented in the input image and improve contrast in the different output images, at least when compared to output images generated for a DoG pyramid.

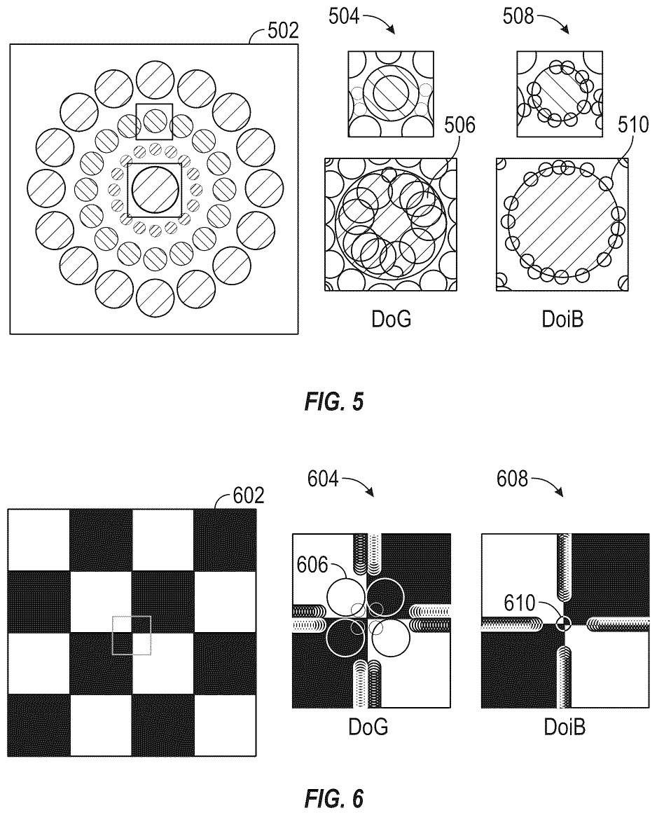

When detecting interest points using a DoiB pyramid, the interest points may tend to appear around the edges of blobs represented in an input image. In contrast, when detecting interest points using a DoG pyramid, the interest points may tend to appear within blobs represented in an input image. This behavior is illustrated in FIG. 5.

For example, as shown in FIG. 5, an input image 502 may represent blobs of varying radii. When using a DoG pyramid for interest point detection, interest point(s) 506 may be detected within one or more of the blobs represented in input image 502 (e.g., as shown at 504). Alternatively, when using a DoiB pyramid for interest point detection, interest point(s) 510 may be detected around the edges of one or more of the blobs represented in input image 502 (e.g., as shown at 508).

Additionally, when detecting interest points using a DoiB pyramid, the interest points may tend to appear along corners and/or edges represented in an input image. In contrast, when detecting interest points using a DoG pyramid, the interest points may tend to appear within the vicinity of corners and/or edges represented in an input image. Put differently, a DoiB pyramid may help to detect corners and/or edges represented in an image more precisely than when a DoG pyramid is used. This behavior is illustrated in FIG. 6.

For example, as shown in FIG. 6, an input image 602 may represent a checkerboard pattern of black and white squares. When using a DoG pyramid for interest point detection, interest point(s) 606 may be detected near (or within the vicinity of) edges and corners represented in input image 602 (e.g., as shown at 604). Alternatively, when using a DoiB pyramid for interest point detection, interest point(s) 610 may be detected along edges and corners represented in input image 602 (e.g., as shown at 608).

### Example Method for Image Processing

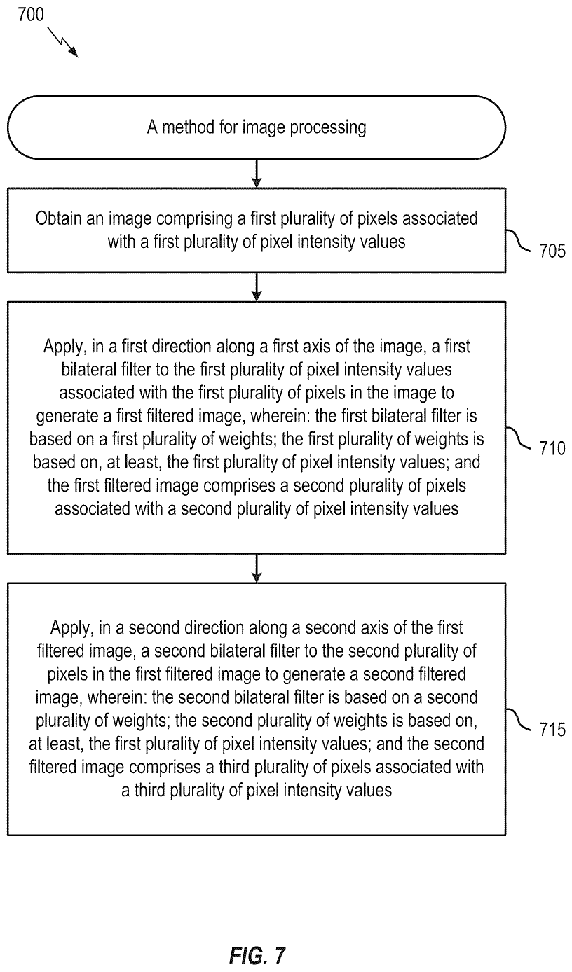

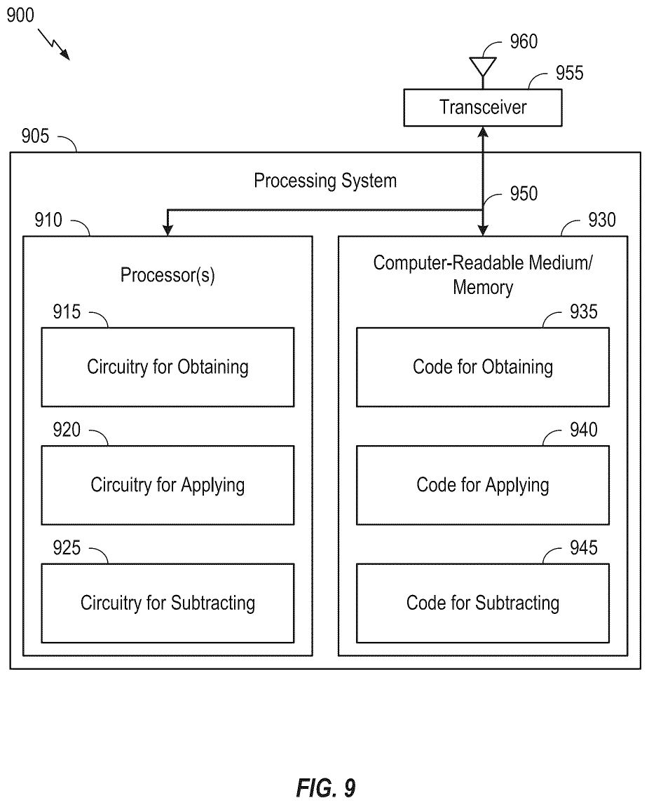

FIG. 7 depicts an example method 700 for image processing. In certain aspects, method 700, or any aspect related to it, may be performed by an apparatus, such as apparatus 900 of FIG. 9, which includes various components operable, configured, or adapted to perform the method 700. Apparatus 900 is described below in further detail.

Method 700 begins at block 705 with obtaining an image comprising a first plurality of pixels associated with a first plurality of pixel intensity values.

Method 700 then proceeds to block 710 with applying, in a first direction along a first axis of the image, a first bilateral filter to the first plurality of pixel intensity values associated with the first plurality of pixels in the image to generate a first filtered image, wherein: the first bilateral filter is based on a first plurality of weights; the first plurality of weights is based on, at least, the first plurality of pixel intensity values; the first filtered image comprises a second plurality of pixels associated with a second plurality of pixel intensity values.

Method 700 then proceeds to block 715 with applying, in a second direction along a second axis of the first filtered image, a second bilateral filter to the second plurality of pixels in the first filtered image to generate a second filtered image, wherein: the second bilateral filter is based on a second plurality of weights; the second plurality of weights is based on, at least, the first plurality of pixel intensity values; and the second filtered image comprises a third plurality of pixels associated with a third plurality of pixel intensity values.

In some aspects, the first axis of the image comprises a vertical axis of the image; and the second axis of the first filtered image comprises a horizontal axis of the first filtered image.

In some aspects, the first plurality of weights is based on: a plurality of spatial Gaussian weights calculated based on a plurality of pixel locations, associated with the first plurality of pixels in the image, along the first axis of the image; and a plurality of intensity Gaussian weights calculated based on the first plurality of pixel intensity values.

In some aspects, the second plurality of weights is based on: a plurality of spatial Gaussian weights calculated based on a plurality of pixel locations, associated with the second plurality of pixels in the first filtered image, along the second axis of the first filtered image; and a plurality of intensity Gaussian weights calculated based on the first plurality of pixel intensity values.

In some aspects, the second filtered image comprises a blurred version of the image that preserves one or more edges represented in the image.

In some aspects, the first plurality of weights and the second plurality of weights are based on, at least, a plurality of inverse intensity Gaussian weights calculated based on the first plurality of pixel intensity values; and the method 700 further comprises subtracting the image from the second filtered image to generate an edge map.

Note that FIG. 7 is just one example of a method, and other methods including fewer, additional, or alternative operations are possible consistent with this disclosure.

### Example Method for Interest Point Detection

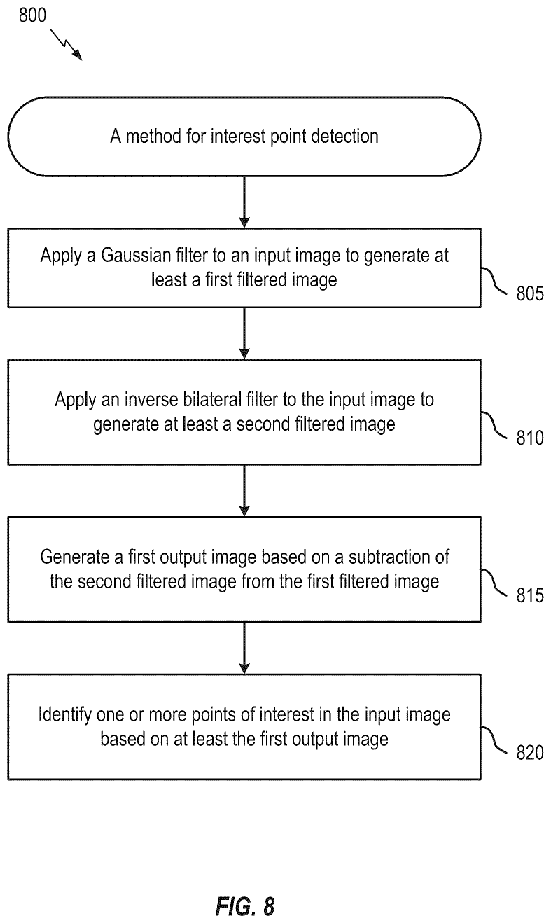

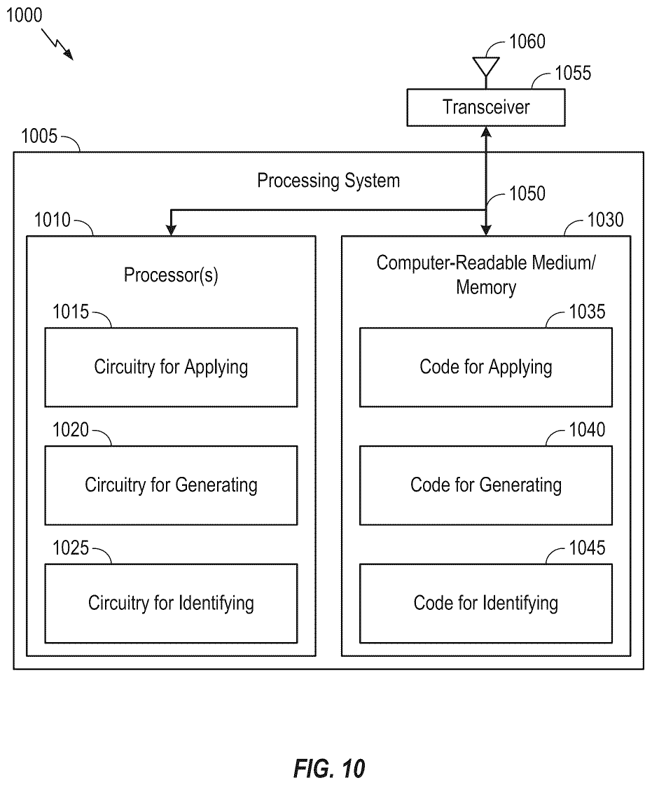

FIG. 8 depicts an example method 800 for interest point detection. In certain aspects, method 800, or any aspect related to it, may be performed by an apparatus, such as apparatus 1000 of FIG. 10, which includes various components operable, configured, or adapted to perform the method 800. Apparatus 1000 is described below in further detail.

Method 800 begins at block 805 with applying a Gaussian filter to an input image to generate at least a first filtered image. As an illustrative example, at 404 in FIG. 4, a Gaussian filter is applied to input image 402 to generate filtered image 410.

Method 800 then proceeds to block 810 with applying an inverse bilateral filter to the input image to generate at least a second filtered image. As an illustrative example, at 404 in FIG. 4, an inverse bilateral filter is applied to input image 402 to generate filtered image 408.

Method 800 then proceeds to block 815 with generating a first output image based on a subtraction of the second filtered image from the first filtered image. As an illustrative example, at 416 in FIG. 4, filtered image 408 is subtracted from filtered image 410 to generate output image 420.

Method 800 then proceeds to block 820 with identifying one or more points of interest in the input image based on at least the first output image. As an illustrative example, at 426 in FIG. 4, one or more points of interest in input image 402 may be identified based on output image 420.

In some aspects, block 805 includes applying the Gaussian filter to the input image according to a first scale; and the method 800 further comprises: applying the Gaussian filter to the input image according to a second scale to generate a third filtered image; and generating a second output image based on the subtraction of the first filtered image from the third filtered image; and block 820 includes identifying the one or more points of interest in the input image further based on the second output image.

In some aspects, the one or more points of interest in the input image correspond to at least one of: one or more edges of a spatial location in the input image; an interior of the spatial location in the input image; or one or more corners represented in the input image.

In some aspects, block 810 includes applying the inverse bilateral filter to the input image according to a first scale; the method 800 further comprises: applying the inverse bilateral filter to the input image according to a second scale to generate a third filtered image; and generating a second output image based on a subtraction of the third filtered image from the first filtered image; and block 820 includes identifying the one or more points of interest in the input image further based on the second output image.

In some aspects, the first output image comprises an edge map.

In some aspects, the second filtered image comprises a blurred version of the input image that preserves one or more edges represented in the input image.

In some aspects, the one or more points of interest in the input image correspond to one or more edges of a spatial location in the input image.

In some aspects, the input image comprises a first plurality of pixels associated with a first plurality of pixel intensity values; and block 810 includes: applying, in a first direction along a first axis of the input image, a first inverse bilateral filter to the first plurality of pixel intensity values associated with the first plurality of pixels in the input image to generate a first bilateral filtered image, wherein: the first inverse bilateral filter is based on a first plurality of weights; the first plurality of weights is based on, at least, the first plurality of pixel intensity values; and the first bilateral filtered image comprises a second plurality of pixels associated with a second plurality of pixel intensity values; and applying, in a second direction along a second axis of the first bilateral filtered image, a second inverse bilateral filter to the second plurality of pixel intensity values associated with the second plurality of pixels in the first bilateral filtered image to generate a second bilateral filtered image, wherein: the second inverse bilateral filter is based on a second plurality of weights; the second plurality of weights is based on, at least, the first plurality of pixel intensity values; the second bilateral filtered image comprises a third plurality of pixels associated with a third plurality of pixel intensity values; and the second filtered image comprises the second bilateral filtered image.

In some aspects, the first axis of the input image comprises a vertical axis of the input image; and the second axis of the first bilateral filtered image comprises a horizontal axis of the first bilateral filtered image.

In some aspects, the first plurality of weights is based on: a plurality of spatial Gaussian weights calculated based on a plurality of pixel locations, associated with the first plurality of pixels in the input image, along the first axis of the input image; and a plurality of inverse intensity Gaussian weights calculated based on the first plurality of pixel intensity values.

In some aspects, the second plurality of weights is based on: a plurality of spatial Gaussian weights calculated based on a plurality of pixel locations, associated with the second plurality of pixels in the first bilateral filtered image, along the second axis of the first bilateral filtered image; and a plurality of inverse intensity Gaussian weights calculated based on the first plurality of pixel intensity values.

In some aspects, method 800, or any aspect related to it, may be performed by an apparatus, such as apparatus 1000 of FIG. 10, which includes various components operable, configured, or adapted to perform the method 800. Apparatus 1000 is described below in further detail.

Note that FIG. 8 is just one example of a method, and other methods including fewer, additional, or alternative operations are possible consistent with this disclosure.

### Example Apparatus for Image Processing

FIG. 9 depicts aspects of an example apparatus 900. In certain aspects, apparatus 900 may comprise a computing device. Apparatus 900 may be implemented in various ways. In certain, apparatus 900 may be implemented within on-site, remote, or cloud-based processing equipment. As another example, apparatus 900 may be implemented on a computing device or a mobile device, such as an edge device.

The apparatus 900 includes a processing system 905 coupled to a transceiver 955 (e.g., a transmitter and/or a receiver). The transceiver 955 is configured to transmit and receive signals for the apparatus 900 via an antenna 960, such as the various signals as described herein. The processing system 905 may be configured to perform processing functions for the apparatus 900, including processing signals received and/or to be transmitted by the apparatus 900.

The processing system 905 includes one or more processors 910 and a computer-readable medium/memory 930. The one or more processors 910 are coupled to a computer-readable medium/memory 930 via a bus 950. The computer-readable medium/memory 930 is a non-transitory computer-readable medium/memory. In certain aspects, the computer-readable medium/memory 930 is configured to store instructions (e.g., computer-executable code), that when executed by the one or more processors 910, cause the one or more processors 910 to perform the method 700 described with respect to FIG. 7, or any aspect related to it, including any operations described in relation to FIG. 7. Note that reference to a processor performing a function of apparatus 900 may include one or more processors performing that function of apparatus 900, such as in a distributed fashion.

In the depicted example, computer-readable medium/memory 930 stores code (e.g., executable instructions), including code for obtaining 935, code for applying 940, and code for subtracting 945. Processing of the code 935-945 may enable and cause the apparatus 900 to perform the method 700 described with respect to FIG. 7, or any aspect related to it. For instance, in some aspects, code for obtaining 935 includes code for obtaining an image comprising a first plurality of pixels associated with a first plurality of pixel intensity values. In some aspects, code for applying 940 includes code for applying, in a first direction along a first axis of the image, a first bilateral filter to the first plurality of pixel intensity values associated with the first plurality of pixels in the image to generate a first filtered image, wherein: the first bilateral filter is based on a first plurality of weights; the first plurality of weights is based on, at least, the first plurality of pixel intensity values; and the first filtered image comprises a second plurality of pixels associated with a second plurality of pixel intensity values. In some aspects, code for applying 940 includes code for applying, in a second direction along a second axis of the first filtered image, a second bilateral filter to the second plurality of pixels in the first filtered image to generate a second filtered image, wherein: the second bilateral filter is based on a second plurality of weights; the second plurality of weights is based on, at least, the first plurality of pixel intensity values; and the second filtered image comprises a third plurality of pixels associated with a third plurality of pixel intensity values.

The one or more processors 910 include circuitry configured to implement (e.g., execute) the code stored in the computer-readable medium/memory 930, including circuitry for obtaining 915, circuitry for applying 920, and circuitry for subtracting 925. Processing with circuitry 915-925 may enable and cause the apparatus 900 to perform the method 700 described with respect to FIG. 7, or any aspect related to it. For instance, in some aspects, circuitry for obtaining 915 includes circuitry for obtaining an image comprising a first plurality of pixels associated with a first plurality of pixel intensity values. In some aspects, circuitry for applying 920 includes circuitry for applying, in a first direction along a first axis of the image, a first bilateral filter to the first plurality of pixel intensity values associated with the first plurality of pixels in the image to generate a first filtered image, wherein: the first bilateral filter is based on a first plurality of weights; the first plurality of weights is based on, at least, the first plurality of pixel intensity values; and the first filtered image comprises a second plurality of pixels associated with a second plurality of pixel intensity values. In some aspects, circuitry for applying 920 includes circuitry for applying, in a second direction along a second axis of the first filtered image, a second bilateral filter to the second plurality of pixels in the first filtered image to generate a second filtered image, wherein: the second bilateral filter is based on a second plurality of weights; the second plurality of weights is based on, at least, the first plurality of pixel intensity values; and the second filtered image comprises a third plurality of pixels associated with a third plurality of pixel intensity values.

More generally, means for communicating, transmitting, sending or outputting for transmission may include transceiver 955 and/or antenna 960 of the apparatus 900 in FIG. 9, and/or one or more processors 910 of the apparatus 900 in FIG. 9. Means for communicating, receiving or obtaining may include transceiver 955 and/or antenna 960 of the apparatus 900 in FIG. 9, and/or one or more processors 910 of the apparatus 900 in FIG. 9.

### Example Apparatus for Interest Point Detection

FIG. 10 depicts aspects of an example apparatus 1000. Apparatus 1000 may be implemented in various ways. For example, apparatus 1000 may be implemented within on-site, remote, or cloud-based processing equipment. As another example, apparatus 1000 may be implemented on a computing device or a mobile device, such as an edge device.

The apparatus 1000 includes a processing system 1005 coupled to a transceiver 1055 (e.g., a transmitter and/or a receiver). The transceiver 1055 is configured to transmit and receive signals for the apparatus 1000 via an antenna 1060, such as the various signals as described herein. The processing system 1005 may be configured to perform processing functions for the apparatus 1000, including processing signals received and/or to be transmitted by the apparatus 1000.

The processing system 1005 includes one or more processors 1010 and a computer-readable medium/memory 1030. In various aspects, the one or more processors 1010 may be representative of the one or more processors 1018 described with respect to FIG. 3. The one or more processors 1010 are coupled to a computer-readable medium/memory 1030 via a bus 1050. In some aspects, the computer-readable medium/memory 1030 may be representative of the one or more memories 320 described with respect to FIG. 3. The computer-readable medium/memory 1030 is a non-transitory computer-readable medium/memory. In certain aspects, the computer-readable medium/memory 1030 is configured to store instructions (e.g., computer-executable code), that when executed by the one or more processors 1010, cause the one or more processors 1010 to perform the method 800 described with respect to FIG. 8, or any aspect related to it, including any operations described in relation to FIG. 8. Note that reference to a processor performing a function of apparatus 1000 may include one or more processors performing that function of apparatus 1000, such as in a distributed fashion.

In the depicted example, computer-readable medium/memory 1030 stores code (e.g., executable instructions), including code for applying 1035, code for generating 1040, and code for identifying 1045. Processing of the code 1035-1045 may enable and cause the apparatus 1000 to perform the method 800 described with respect to FIG. 8, or any aspect related to it. For instance, in some aspects, code for applying 1035 includes code for applying a Gaussian filter to an input image to generate at least a first filtered image. In some aspects, code for applying 1035 includes code for applying an inverse bilateral filter to the input image to generate at least a second filtered image. In some aspects, code for generating 1040 includes code for generating a first output image based on a subtraction of the first filtered image from the second filtered image. In some aspects, code for identifying 1045 includes code for identifying one or more points of interest in the input image based on at least the first output image.

The one or more processors 1010 include circuitry configured to implement (e.g., execute) the code stored in the computer-readable medium/memory 1030, including circuitry for applying 1015, circuitry for generating 1020, and circuitry for identifying 1025. Processing with circuitry 1015-1025 may enable and cause the apparatus 1000 to perform the method 800 described with respect to FIG. 8, or any aspect related to it. For instance, in some aspects, circuitry for applying 1015 includes circuitry for applying a Gaussian filter to an input image to generate at least a first filtered image. In some aspects, circuitry for applying 1015 includes circuitry for applying an inverse bilateral filter to the input image to generate at least a second filtered image. In some aspects, circuitry for generating 1020 includes circuitry for generating a first output image based on a subtraction of the first filtered image from the second filtered image. In some aspects, circuitry for identifying 1025 includes circuitry for identifying one or more points of interest in the input image based on at least the first output image.

More generally, means for communicating, transmitting, sending or outputting for transmission may include transceiver 1055 and/or antenna 1060 of the apparatus 1000 in FIG. 10, and/or one or more processors 1010 of the apparatus 1000 in FIG. 10. Means for communicating, receiving or obtaining may include transceiver 1055 and/or antenna 1060 of the apparatus 1000 in FIG. 10, and/or one or more processors 1010 of the apparatus 1000 in FIG. 10.

### EXAMPLE CLAUSES

Implementation examples are described in the following numbered clauses:
Clause 1: A method, comprising: obtaining an image comprising a first plurality of pixels associated with a first plurality of pixel intensity values; applying, in a first direction along a first axis of the image, a first bilateral filter to the first plurality of pixel intensity values associated with the first plurality of pixels in the image to generate a first filtered image, wherein: the first bilateral filter is based on a first plurality of weights; the first plurality of weights is based on, at least, the first plurality of pixel intensity values; the first filtered image comprises a second plurality of pixels associated with a second plurality of pixel intensity values; and applying, in a second direction along a second axis of the first filtered image, a second bilateral filter to the second plurality of pixels in the first filtered image to generate a second filtered image, wherein: the second bilateral filter is based on a second plurality of weights; the second plurality of weights is based on, at least, the first plurality of pixel intensity values; and the second filtered image comprises a third plurality of pixels associated with a third plurality of pixel intensity values.
Clause 2: The method of Clause 1, wherein: the first axis of the image comprises a vertical axis of the image; and the second axis of the first filtered image comprises a horizontal axis of the first filtered image.
Clause 3: The method of any one of Clauses 1-2, wherein the first plurality of weights is based on: a plurality of spatial Gaussian weights calculated based on a plurality of pixel locations, associated with the first plurality of pixels in the image, along the first axis of the image; and a plurality of intensity Gaussian weights calculated based on the first plurality of pixel intensity values.
Clause 4: The method of any one of Clauses 1-3, wherein the second plurality of weights is based on: a plurality of spatial Gaussian weights calculated based on a plurality of pixel locations, associated with the second plurality of pixels in the first filtered image, along the second axis of the first filtered image; and a plurality of intensity Gaussian weights calculated based on the first plurality of pixel intensity values.
Clause 5: The method of any one of Clauses 1-4, wherein the second filtered image comprises a blurred version of the image that preserves one or more edges represented in the image.
Clause 6: The method of any one of Clauses 1-5, wherein: the first plurality of weights and the second plurality of weights are based on, at least, a plurality of inverse intensity Gaussian weights calculated based on the first plurality of pixel intensity values; and the method further comprises subtracting the image from the second filtered image to generate an edge map.
Clause 7: A method, comprising: applying a Gaussian filter to an input image to generate at least a first filtered image; applying an inverse bilateral filter to the input image to generate at least a second filtered image; generating a first output image based on a subtraction of the second filtered image from the first filtered image; and identifying one or more points of interest in the input image based on at least the first output image.
Clause 8: The method of Clause 7, wherein: applying the Gaussian filter to the input image to generate the first filtered image comprises applying the Gaussian filter to the input image according to a first scale; and the method further comprises: applying the Gaussian filter to the input image according to a second scale to generate a third filtered image; and generating a second output image based on a subtraction of the first filtered image from the third filtered image; and identifying the one or more points of interest in the input image comprises identifying the one or more points of interest in the input image further based on the second output image.
Clause 9: The method of Clause 8, wherein the one or more points of interest in the input image correspond to at least one of: one or more edges of a spatial location in the input image; an interior of the spatial location in the input image; or one or more corners represented in the input image.
Clause 10: The method of any one of Clauses 7-8, wherein: applying the inverse bilateral filter to the input image to generate the second filtered image comprises applying the inverse bilateral filter to the input image according to a first scale; the method further comprises: applying the inverse bilateral filter to the input image according to a second scale to generate a third filtered image; and generating a second output image based on a subtraction of the third filtered image from the first filtered image; and identifying the one or more points of interest in the input image comprises identifying the one or more points of interest in the input image further based on the second output image.
Clause 11: The method of any one of Clauses 7-10, wherein the first output image comprises an edge map.
Clause 12: The method of any one of Clauses 7-11, wherein the second filtered image comprises a blurred version of the input image that preserves one or more edges represented in the input image.
Clause 13: The method of any one of Clauses 7-12, wherein the one or more points of interest in the input image correspond to one or more edges of a spatial location in the input image.
Clause 14: The method of any one of Clauses 7-13, wherein: the input image comprises a first plurality of pixels associated with a first plurality of pixel intensity values; and applying the inverse bilateral filter to the input image comprises: applying, in a first direction along a first axis of the input image, a first inverse bilateral filter to the first plurality of pixel intensity values associated with the first plurality of pixels in the input image to generate a first bilateral filtered image, wherein: the first inverse bilateral filter is based on a first plurality of weights; the first plurality of weights is based on, at least, the first plurality of pixel intensity values; and the first bilateral filtered image comprises a second plurality of pixels associated with a second plurality of pixel intensity values; and applying, in a second direction along a second axis of the first bilateral filtered image, a second inverse bilateral filter to the second plurality of pixel intensity values associated with the second plurality of pixels in the first bilateral filtered image to generate a second bilateral filtered image, wherein: the second inverse bilateral filter is based on a second plurality of weights; the second plurality of weights is based on, at least, the first plurality of pixel intensity values; the second bilateral filtered image comprises a third plurality of pixels associated with a third plurality of pixel intensity values; and the second filtered image comprises the second bilateral filtered image.
Clause 15: The method of Clause 14, wherein: the first axis of the input image comprises a vertical axis of the input image; and the second axis of the first bilateral filtered image comprises a horizontal axis of the first bilateral filtered image.
Clause 16: The method of Clause 14, wherein the first plurality of weights is based on: a plurality of spatial Gaussian weights calculated based on a plurality of pixel locations, associated with the first plurality of pixels in the input image, along the first axis of the input image; and a plurality of inverse intensity Gaussian weights calculated based on the first plurality of pixel intensity values.
Clause 17: The method of Clause 14, wherein the second plurality of weights is based on: a plurality of spatial Gaussian weights calculated based on a plurality of pixel locations, associated with the second plurality of pixels in the first bilateral filtered image, along the second axis of the first bilateral filtered image; and a plurality of inverse intensity Gaussian weights calculated based on the first plurality of pixel intensity values.
Clause 18: One or more apparatuses, comprising: one or more memories comprising executable instructions; and one or more processors configured to execute the executable instructions and cause the one or more apparatuses to perform a method in accordance with any one of Clauses 1-17.
Clause 19: One or more apparatuses, comprising: one or more memories; and one or more processors, coupled to the one or more memories, configured to cause the one or more apparatuses to perform a method in accordance with any one of Clauses 1-17.
Clause 20: One or more apparatuses, comprising: one or more memories; and one or more processors, coupled to the one or more memories, configured to perform a method in accordance with any one of Clauses 1-17.
Clause 21: One or more apparatuses, comprising means for performing a method in accordance with any one of Clauses 1-17.
Clause 22: One or more non-transitory computer-readable media comprising executable instructions that, when executed by one or more processors of one or more apparatuses, cause the one or more apparatuses to perform a method in accordance with any one of Clauses 1-17.
Clause 23: One or more computer program products embodied on one or more computer-readable storage media comprising code for performing a method in accordance with any one of Clauses 1-17.
Clause 24: One or more apparatuses, comprising: a processing system that includes one or more processors and one or more memories coupled with the one or more processors, the processing system configured to cause the one or more apparatuses to perform a method in accordance with any one of Clauses 1-17.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system that includes one or more processors and one or more memories coupled with the one or more processors, the processing system configured to cause the apparatus to:
apply a Gaussian filter to an input image to generate at least a first filtered image;
apply an inverse bilateral filter to the input image to generate at least a second filtered image;
generate a first output image based on a subtraction of the second filtered image from the first filtered image; and
identify one or more points of interest in the input image based on at least the first output image.

2. The apparatus of claim 1, wherein:
to cause the apparatus to apply the Gaussian filter to the input image to generate the first filtered image, the processing system is configured to cause the apparatus to apply the Gaussian filter to the input image according to a first scale;
the processing system is configured to cause the apparatus to:
apply the Gaussian filter to the input image according to a second scale to generate a third filtered image; and
generate a second output image based on a subtraction of the first filtered image from the third filtered image; and
to cause the apparatus to identify the one or more points of interest in the input image, the processing system is configured to cause the apparatus to identify the one or more points of interest in the input image further based on the second output image.

3. The apparatus of claim 2, wherein the one or more points of interest in the input image correspond to at least one of:
one or more edges of a spatial location in the input image;
an interior of the spatial location in the input image; or
one or more corners represented in the input image.

4. The apparatus of claim 1, wherein:
to cause the apparatus to apply the inverse bilateral filter to the input image to generate the second filtered image, the processing system is configured to cause the apparatus to apply the inverse bilateral filter to the input image according to a first scale;
the processing system is configured to cause the apparatus to:
apply the inverse bilateral filter to the input image according to a second scale to generate a third filtered image; and
generate a second output image based on a subtraction of the third filtered image from the first filtered image; and
to cause the apparatus to identify the one or more points of interest in the input image, the processing system is configured to cause the apparatus to identify the one or more points of interest in the input image further based on the second output image.

5. The apparatus of claim 1, wherein the first output image comprises an edge map.

6. The apparatus of claim 1, wherein the second filtered image comprises a blurred version of the input image that preserves one or more edges represented in the input image.

7. The apparatus of claim 1, wherein the one or more points of interest in the input image correspond to one or more edges of a spatial location in the input image.

8. The apparatus of claim 1, wherein:
the input image comprises a first plurality of pixels associated with a first plurality of pixel intensity values; and
to cause the apparatus to apply the inverse bilateral filter to the input image, the processing system is configured to cause the apparatus to:
apply, in a first direction along a first axis of the input image, a first inverse bilateral filter to the first plurality of pixel intensity values associated with the first plurality of pixels in the input image to generate a first bilateral filtered image, wherein:
the first inverse bilateral filter is based on a first plurality of weights;
the first plurality of weights is based on, at least, the first plurality of pixel intensity values; and
the first bilateral filtered image comprises a second plurality of pixels associated with a second plurality of pixel intensity values; and
apply, in a second direction along a second axis of the first bilateral filtered image, a second inverse bilateral filter to the second plurality of pixel intensity values associated with the second plurality of pixels in the first bilateral filtered image to generate a second bilateral filtered image, wherein:
the second inverse bilateral filter is based on a second plurality of weights;
the second plurality of weights is based on, at least, the first plurality of pixel intensity values;
the second bilateral filtered image comprises a third plurality of pixels associated with a third plurality of pixel intensity values; and
the second filtered image comprises the second bilateral filtered image.

9. The apparatus of claim 8, wherein:
the first axis of the input image comprises a vertical axis of the input image; and
the second axis of the first bilateral filtered image comprises a horizontal axis of the first bilateral filtered image.

10. The apparatus of claim 8, wherein the first plurality of weights is based on:
a plurality of spatial Gaussian weights calculated based on a plurality of pixel locations, associated with the first plurality of pixels in the input image, along the first axis of the input image; and
a plurality of inverse intensity Gaussian weights calculated based on the first plurality of pixel intensity values.

11. The apparatus of claim 8, wherein the second plurality of weights is based on:
a plurality of spatial Gaussian weights calculated based on a plurality of pixel locations, associated with the second plurality of pixels in the first bilateral filtered image, along the second axis of the first bilateral filtered image; and
a plurality of inverse intensity Gaussian weights calculated based on the first plurality of pixel intensity values.

12. A method for interest point detection by an apparatus, comprising:
applying a Gaussian filter to an input image to generate at least a first filtered image;
applying an inverse bilateral filter to the input image to generate at least a second filtered image;
generating a first output image based on a subtraction of the second filtered image from the first filtered image; and
identifying one or more points of interest in the input image based on at least the first output image.

13. The method of claim 12, wherein:
applying the Gaussian filter to the input image to generate the first filtered image comprises applying the Gaussian filter to the input image according to a first scale;
the method further comprises:
applying the Gaussian filter to the input image according to a second scale to generate a third filtered image; and
generating a second output image based on a subtraction of the first filtered image from the third filtered image; and
identifying the one or more points of interest in the input image comprises identifying the one or more points of interest in the input image further based on the second output image.

14. The method of claim 13, wherein the one or more points of interest in the input image correspond to at least one of:
one or more edges of a spatial location in the input image;
an interior of the spatial location in the input image; or
one or more corners represented in the input image.

15. The method of claim 12, wherein:
applying the inverse bilateral filter to the input image to generate the second filtered image comprises applying the inverse bilateral filter to the input image according to a first scale;
the method further comprises:
applying the inverse bilateral filter to the input image according to a second scale to generate a third filtered image; and
generating a second output image based on a subtraction of the third filtered image from the first filtered image; and
identifying the one or more points of interest in the input image comprises identifying the one or more points of interest in the input image further based on the second output image.

16. The method of claim 12, wherein the first output image comprises an edge map.

17. The method of claim 12, wherein the second filtered image comprises a blurred version of the input image that preserves one or more edges represented in the input image.

18. The method of claim 12, wherein the one or more points of interest in the input image correspond to one or more edges of a spatial location in the input image.

19. The method of claim 12, wherein:
the input image comprises a first plurality of pixels associated with a first plurality of pixel intensity values; and
applying the inverse bilateral filter to the input image comprises:
applying, in a first direction along a first axis of the input image, a first inverse bilateral filter to the first plurality of pixel intensity values associated with the first plurality of pixels in the input image to generate a first bilateral filtered image, wherein:
the first inverse bilateral filter is based on a first plurality of weights;
the first plurality of weights is based on, at least, the first plurality of pixel intensity values; and
the first bilateral filtered image comprises a second plurality of pixels associated with a second plurality of pixel intensity values; and
applying, in a second direction along a second axis of the first bilateral filtered image, a second inverse bilateral filter to the second plurality of pixel intensity values associated with the second plurality of pixels in the first bilateral filtered image to generate a second bilateral filtered image, wherein:
the second inverse bilateral filter is based on a second plurality of weights;
the second plurality of weights is based on, at least, the first plurality of pixel intensity values;
the second bilateral filtered image comprises a third plurality of pixels associated with a third plurality of pixel intensity values; and
the second filtered image comprises the second bilateral filtered image.

20. One or more non-transitory computer-readable media comprising executable instructions that, when executed by one or more processors of an apparatus, cause the apparatus to perform operations comprising:
applying a Gaussian filter to an input image to generate at least a first filtered image;
applying an inverse bilateral filter to the input image to generate at least a second filtered image;
generating a first output image based on a subtraction of the second filtered image from the first filtered image; and
identifying one or more points of interest in the input image based on at least the first output image.
